(19) United States
(12) Patent Application Publication
(10) Pub. No.: US 2025/0311831 A1
(43) Pub. Date: Oct. 9, 2025

(54) UV NAIL LAMP WITH LIGHT GUIDE

(71) Applicant: Dashing Diva Franchise Corp., Port Washington, NY (US)

(72) Inventor: Sung Yong Chang, Roslyn Heights, NY (US)

(21) Appl. No.: 18/627,639

(22) Filed: Apr. 5, 2024

(51) Int. Cl. A45D 29/00; A45D 44/00; F26B 3/28; F26B 9/00

(52) U.S. Cl. CPC A45D 29/00; A45D 44/00; F26B 3/28; F26B 9/003; A45D 2200/205

(57) ABSTRACT

A nail lamp for curing a light-curable nail product on a user's nail. The nail lamp includes a housing, a curing plane defined by the housing, at least one nail curing light source supported by the housing and at least one image projecting light source supported by the housing. The housing has an open cavity forming a nail treatment space, wherein the nail treatment space is bounded by the housing and the curing plane. The at least one nail curing light source transmits nail curing light onto the curing plane in an optimal curing area and the at least one image projecting light source projects a visible light image on the curing plane adjacent the optimal curing area for guiding a positioning of the user's nail in the optimal curing area.

### BACKGROUND OF THE INVENTION

The present invention relates generally to a nail lamp for curing a light-curable nail product (e.g., nail polish, gels or acrylics) on a user's nails. More particularly, the present invention relates to a nail lamp that provides a visible image for guiding the user to optimally position the nails under the nail lamp.

Nail polish and artificial nails have been used for many years to enhance the cosmetic appearance of the fingers and toes. In the case of nail polish, one or more colors and/or decorative designs are typically stenciled, air-brushed or hand-painted on the fingernail and/or toe nail to provide an aesthetic appeal. Intricate ornamentation provided by hand-painting requires a great deal of skill and expertise to achieve satisfactory results.

A nail coating may be classified into two categories: nail polish and artificial nail covers. Nail polish typically comprises various solid components, which are dissolved and/or suspended in non-reactive solvents. Artificial nail covers may include full size artificial nails, nail decals or appliqués that are applied to natural nails with an adhesive to enhance the cosmetic appearance of the nail.

Various nail polish materials have been used in the nail art. Recently, ultraviolet (UV) gel has become quite popular. The UV gel hardens under UV light and has many advantages. It does not break easily because it is flexible and soft, does not suffer discoloration even after exposure to sunlight and exhibits excellent gloss. The UV gel is obtained by applying a composition for forming a UV gel layer on a natural nail and curing by irradiating UV. Since the UV gel can provide a glossy and shiny effect to the natural nail, it is widely used.

UV nail lamps are available for the salon and home to cure UV-curable nail polish. These nail lamps typically have one or more UV light sources in the form of UV light emitting diodes (LEDs), UV fluorescent tubes or bulbs that emit UV light for curing UV-curable gel nail polish. The nail lamp is typically powered from an exterior power source, such as a wall socket, or by a rechargeable battery pack.

Traditional nail lamps tend to produce uneven light depending on where the user's nails are positioned under the light sources. As a result, a user's nails can be exposed to different intensities of light output, which causes the nails to dry at different times or to cure unevenly.

Some nail lamps of the prior art have attempted to alleviate this problem by providing physical guides or stops to help users to position the nails under the light source within an open treatment area. For example, it is known to provide a lamp with a hand/foot platform having a physical barrier, such as a “U” shaped device, where the user has only one way to position the nails towards the treatment area. Other prior art devices have a bottom finger plate, which has indentions or side by side depressions that are adapted to support a user's fingers when the user places a hand beneath the light source. Other devices have stops that can provide a tactile gauge for the user to indicate where to place the fingers during curing.

Such mechanical guides or stops add to the complexity of the design of the nail lamp. Specifically, additional structure or components are required in order to provide such mechanical guides or stops, which, in turn, increase the costs of manufacturing the lamp. Accordingly, it would be desirable to provide a nail lamp for curing a light-curable nail product on a user's nails with a simple guide to assist the user to optimally position the nails under the nail lamp.

### SUMMARY OF THE INVENTION

The present invention is a nail lamp for curing a light-curable nail product on a user's nail. The nail lamp includes a housing, a curing plane defined by the housing, at least one nail curing light source supported by the housing and at least one image projecting light source supported by the housing. The housing has an open cavity forming a nail treatment space, wherein the nail treatment space is bounded by the housing and the curing plane. The at least one nail curing light source transmits nail curing light onto the curing plane in an optimal curing area and the at least one image projecting light source projects a visible light image on the curing plane adjacent the optimal curing area for guiding a positioning of the user's nail in the optimal curing area.

In one embodiment of the invention, the housing includes an upper portion and at least two legs extending from the upper portion for supporting the upper portion at a distance from a surface. Each of the at least two legs terminate at a distal end, wherein the curing plane is defined by the distal ends of the at least two legs on the surface. In this embodiment, the at least two legs are preferably foldable with respect to the housing upper portion.

The at least one nail curing light source is preferably an ultra-violet (UV) light source. More preferably, the at least one nail curing light source is a UV light emitting diode (LED).

The at least one image projecting light source is preferably a light emitting diode (LED). The at least one image projecting light source can be a laser light source. The at least one image projecting light source can include a lens for focusing the light from the light source into the visible light image. In any case, the light image can be a point image or a line image.

In some embodiments, the nail lamp further includes a circuit board contained within the housing, wherein the at least one nail curing light source and the at least one image projecting light source are mounted on the circuit board.

In some embodiments of the present invention, the housing includes an upper portion and a bottom platform disposed at a distance from the upper portion. In these embodiments, the bottom platform has an upper surface facing the upper portion, wherein the curing plane is defined by the upper surface of the bottom platform.

The present invention also involves a method for curing a light-curable nail product on a user's nail. The method includes transmitting nail curing light from at least one nail curing light source onto a curing plane in an optimal curing area, projecting a visible light image from at least one image projecting light source on the curing plane adjacent the optimal curing area and positioning the user's nail with respect to the visible light image in the optimal curing area.

As described above, the nail curing light can be transmitted from an ultra-violet (UV) light source, such as UV light emitting diode (LED). Also, the visible light image can be projected by a light emitting diode (LED), or by a laser light source. The visible light image can be a point image or a line image.

The preferred embodiments, as well as other objects, features and advantages of the present invention will become apparent from the following detailed description considered in conjunction with the accompanying drawings. It is to be understood, however, that the drawings are intended as an illustration only and not as a definition of the limits of the invention. The scope will be pointed out in the claims.

### BRIEF DESCRIPTION OF THE DRAWINGS

FIG. 1 is a top perspective view of an embodiment of a nail lamp according to the present invention.

FIG. 2 is a bottom view of the nail lamp shown in FIG. 1.

FIG. 3 is a bottom view of the nail lamp shown in FIGS. 1 and 2 with the legs folded in toward the housing.

FIG. 4 is a top perspective view of another embodiment of the nail lamp according to the present invention in which the light image is a point image.

FIG. 5 is a top perspective view of another embodiment of the nail lamp according to the present invention in which the light image is a single line image.

FIG. 6 is a top perspective view of another embodiment of the nail lamp according to the present invention in which the light image is a double line image.

### DETAILED DESCRIPTION OF THE INVENTION

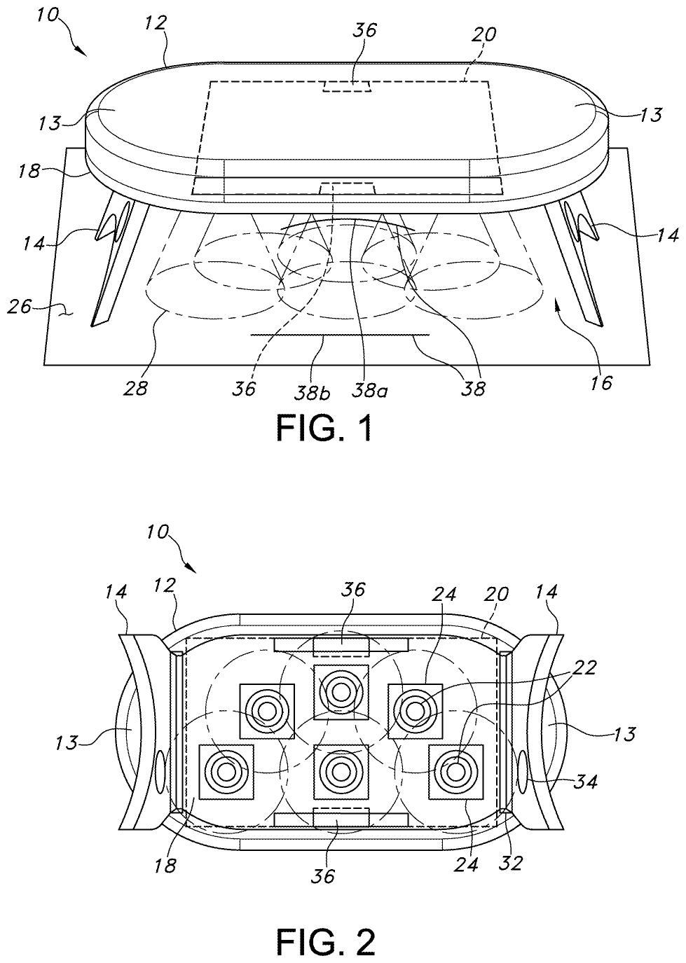

Referring first to FIGS. 1-3, the nail lamp 10 of the present invention generally includes a lamp housing 12 having an open cavity forming a nail treatment space 16. In one embodiment, as shown in FIGS. 1-3, the housing 12 includes an upper portion 13 supported on two legs 14 extending downwardly from the upper portion of the housing. In other embodiments (not shown), the housing 12 can be single body in the shape of an arch, or a dome, for example, that rests on a surface. In the embodiment shown in FIGS. 1-3, the nail treatment space 16, as will be described in further detail below, is defined between the legs 14 and beneath a bottom surface 18 of the housing 12.

A circuit board 20 is contained within the housing 12 adjacent the bottom surface 18. The circuit board supports a plurality of nail curing light sources 22, which are used to cure one or more fingernails or toenails positioned within the nail treatment space 16. To allow the curing light of the nail curing light sources 22 to pass from the circuit board 20 within the housing 12 to the nail treatment space 16, the bottom surface 18 of the housing is provided with a respective opening 24 for each of the individual nail curing light sources.

As used herein, “light source” is defined broadly to include any light source or light-generating mechanism. The nail lamp 10 may include only a single light source or a plurality of light sources with the maximum number of sources only limited by the size of the housing 12. As shown in FIGS. 1-3, the light sources are mounted on the circuit board 20, but the light sources can be contained anywhere within or otherwise supported at any location on the housing in other manners. The light sources may also be located at the sides of the nail treatment space 16 on the legs 14, for example.

Each of the nail curing light sources 22 may be of any suitable construction and configuration, and may vary across embodiments. For example, in various embodiments the light sources 22 can be UV light bulbs, fluorescent light bulbs, infrared light bulbs, or candescent light bulbs. In some embodiments, the light sources 22 may have a shape of a tube or of a combination of tubes. In some embodiments, the light sources 22 may include light emitting diodes (LEDs). In the embodiment shown in FIGS. 1-3, the light sources 22 comprise an array of sources (including but not limited to an array of LEDs) which may generally be disposed to have a shape (e.g., physically or in terms of light output) of the nails on a hand or foot; or a semicircular shape formed by a region connecting all of the nails on a hand or a foot.

In an embodiment, the light sources 22 may be configured to emit a wavelength of light configured to photo chemically cure gel or acrylic applied to the finger or toe nails of the hands or feet placed in the nail treatment space. In this embodiment, the nail curing light sources 22 are ultraviolet (UV) light sources that emit ultraviolet light for curing UV-curable nail gel. Ultraviolet radiation with a wavelength range of 365 to 425 nm is used to cure some artificial nails. Ultraviolet light sources with wavelengths as low as 100 nm can also be used. Visible light with wavelength of 425 nm or higher can also be used. The choice of wavelength or wavelengths to cure an artificial nail or nail polish will be depend on the photo initiators, the colors of the pigments and other aspects of the nail polish or artificial nail.

The light sources preferably use relatively low power, wherein the nail lamp 10 can be powered from an exterior power source, such as a wall socket, or by a rechargeable battery pack. In instances, the power supply can include both an electrical plug for direct AC power connection and DC rechargeable batteries. A battery compartment (not shown) of the housing 12 of the nail lamp can be provided to hold the battery pack, which is removable without disassembling the nail lamp. A control panel (not shown) can also be provided on the housing 12 for selecting curing time of the nail lamp. The nail lamp 10 is easily transportable to different locations and can be used even when a wall socket is unavailable.

The legs 14 are intended to rest on a surface and support the housing at an optimal vertical distance from the surface for curing the nails. Thus, in the embodiment shown in FIGS. 1-3, the bottoms of the legs 14 define an optimal curing plane 26, which coincides with any arbitrary surface on which the nail lamp 10 rests upon. The nail curing light sources 22, as a group, emit light onto the optimal curing plane 26 in an optimal curing area 28, which is determined by the arrangement of the nail curing light sources within the housing 12.

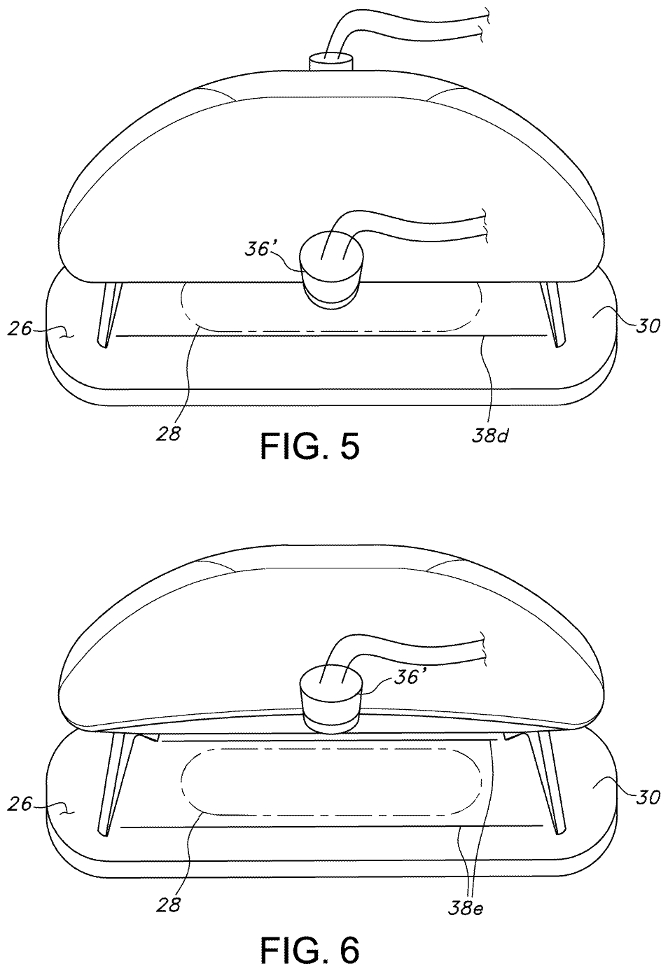

In an alternative embodiment, as shown in FIGS. 4-6, the nail lamp 10′ may include a bottom platform 30 connected to the bottom of the legs 14. In this embodiment, the top surface of the bottom platform 30 defines the optimal curing plane 26 upon which light from the nail curing light sources 22 is directed in the optimal curing area 28. In this case, the user will rest the fingers or toes on the top surface of the bottom platform underneath the lamp housing 12 for curing.

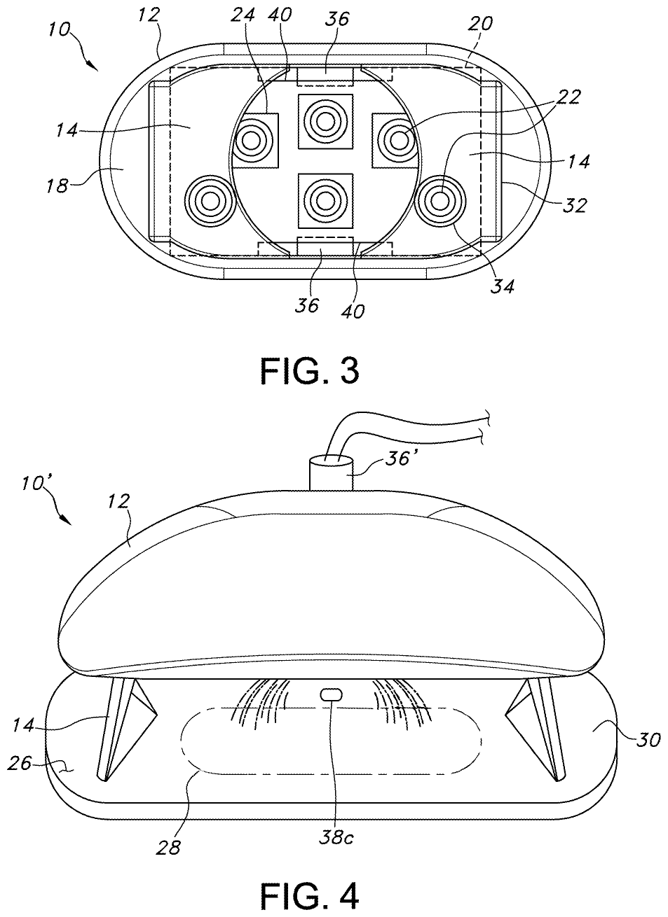

Returning to the embodiment shown in FIGS. 1-3, the legs 14 are preferably foldable with respect to the housing 12. FIGS. 1 and 2 show the legs 14 extended to allow the nail lamp to be supported on a surface. FIG. 3 shows the legs 14 folded about a hinge 32, for example, to stow the legs against the bottom surface 18 of the housing 12. In this embodiment, the legs 14 are shaped to allow unobstructed transmittance of the light from the nail curing light sources 22 even when the legs are folded against the bottom surface of the housing 12. For example, the legs 14 may be arch-shaped and/or include one or more openings 32 to allow light from the curing light sources to pass through the legs.

According to the present invention, the nail lamp 10 further includes at least one image projecting light source 36 for projecting a light image 38 on the optimal curing plane 26 of the nail treatment space 16. The light image 38 is projected on the optimal curing plane 26 of the nail treatment space 16 at a position immediately adjacent to the optimal curing area 28. The light image 38 provides a visual guide for the user to place a fingernail or the toenail in an optimum position within the nail treatment space 16.

For example, a light image 38 in the form of a curved line 38a can be projected by one of the image projecting light sources 36 on the optimal curing plane 26 at a front boundary of the nail treatment space 16 and a light image in the form of a straight line 38b can be projected on the on the optimal curing plane 26 at a rear boundary of the nail treatment space. The user can place the nails near the front boundary but beyond the rear boundary and is thus provided with a convenient guide for positioning the nails to be cured beneath the housing 12.

The light image 38 is not restricted to a curved line image 38a or a straight line image 38b. For example, the light image 38 can be a point or dot light image 38c, as shown in FIG. 4, or a full single line 38d or full double lines 38d extending from one leg to the opposite leg across the optimal curing plane 26 of the nail treatment space 16. What is important is that the light image 38 is visible on a surface upon which the user will place the fingers or toes.

The image projecting light source 36 can take the form of an incandescent bulb, a fluorescent bulb, a light emitting diode (LED) or any other light source contained within or supported by the housing. In the embodiment shown in FIGS. 1-3, the image projecting light source is a light emitting diode (LED) supported on and powered through the circuit board 20. In this case, the bottom surface 18 of the housing 12 will include an image projecting light source opening 40 to allow the light from the image projecting light source 36 to project out of the housing 12. The image projecting light source 36 may also include a lens (not shown) for focusing the light from the light source into the light image 38.

FIGS. 4-6 show an alternative embodiment of the present invention in which the image projecting light source is in the form of an LED laser light source 36′. The LED laser light source 36′ can be fixed to or otherwise supported at a front edge portion or rear edge portion of the housing so as to be able to project an image on the optimal curing plane 26 of the nail treatment space 16 at a position immediately adjacent to the optimal curing area 28.

As mentioned above, the image 38 projected by the laser light source 36′ can take the form of a single point 38c, a single line 38d extending between the legs 14 or a double line 38e extending between the legs. Here too, the images 38 projected by the laser light source 32′ provide a convenient visible guide for positioning the nails in an optimum location within the nail treatment space.

In the case of a single point light image, a laser pointer can be used for the laser light source 36′. In the case of a single line or double line light image, a line laser can be used for the laser light source 36′. As is known in the art, a line laser is a device that employs a laser and an optical lens to project the laser beam as a line rather than a point (e.g. laser pointer). This may be achieved by passing the beam through a cylindrical lens or a Powell lens. Depending on the application, independent line lasers may be used to generate lines, or multiple line lasers may be used together to produce crosses or other composite patterns.

As a result of the present invention, a UV LED nail lamp with the unique function of guiding a user to position the hands or the feet into the treatment area is provided. Specifically, the present invention provides a lighted guide for the user to locate the optimal treatment area. The image projecting light guide source can be an aiming point, a perimeter marking or lines to show the location of the optimal treatment area. The lighted source can be a strong beam of light such as a laser which can be seen by the human eye and can easily be distinguished by the human eye from any other surrounding light sources. The invention is unique in the fact that there are no UV LED nail lamps currently in the market that are using any type of light to guide user to the treatment area.

Although preferred embodiments of the present device have been described herein with reference to the accompanying drawings, it is to be understood that the herein device is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A nail lamp for curing a light-curable nail product on a user's nail, the nail lamp comprising:
a housing having an open cavity forming a nail treatment space;
a curing plane defined by the housing, the nail treatment space being bounded by the housing and the curing plane;
at least one nail curing light source supported by the housing, the at least one nail curing light source transmitting nail curing light onto the curing plane in an optimal curing area; and
at least one image projecting light source supported by the housing, the at least one image projecting light source projecting a visible light image on the curing plane adjacent the optimal curing area for guiding a positioning of the user's nail in the optimal curing area.

2. The nail lamp as defined in claim 1, wherein the housing comprises:
an upper portion; and
at least two legs extending from the upper portion for supporting the upper portion at a distance from a surface, each of the at least two legs terminating at a distal end, wherein the curing plane is defined by the distal ends of the at least two legs on the surface.

3. The nail lamp as defined in claim 2, wherein the at least two legs are foldable with respect to the housing upper portion.

4. The nail lamp as defined in claim 1, wherein the at least one nail curing light source is an ultra-violet (UV) light source.

5. The nail lamp as defined in claim 4, wherein the UV light source is a light emitting diode (LED).

6. The nail lamp as defined in claim 1, wherein the at least one image projecting light source is a light emitting diode (LED).

7. The nail lamp as defined in claim 1, wherein the at least one image projecting light source is a laser light source.

8. The nail lamp as defined in claim 1, wherein the visible light image is a point image or a line image.

9. The nail lamp as defined in claim 1, further comprising a circuit board contained within the housing, the at least one nail curing light source and the at least one image projecting light source being mounted on the circuit board.

10. The nail lamp as defined in claim 1, wherein the housing comprises:
an upper portion; and
a bottom platform disposed at a distance from the upper portion, the bottom platform having an upper surface facing the upper portion, wherein the curing plane is defined by the upper surface of the bottom platform.

11. The nail lamp as defined in claim 1, wherein the at least one image projecting light source comprises a lens for focusing the light from the light source into the visible light image.

12. A method for curing a light-curable nail product on a user's nail, the method comprising:
transmitting nail curing light from at least one nail curing light source onto a curing plane in an optimal curing area;
projecting a visible light image from at least one image projecting light source on the curing plane adjacent the optimal curing area; and
positioning the user's nail with respect to the visible light image in the optimal curing area.

13. The method as defined in claim 12, wherein nail curing light is transmitted from an ultra-violet (UV) light source.

14. The method as defined in claim 13, wherein the UV light source is a light emitting diode (LED).

15. The method as defined in claim 12, wherein the visible light image is projected by a light emitting diode (LED).

16. The method as defined in claim 12, wherein the visible light image is projected by a laser light source.

17. The method as defined in claim 12, wherein the visible light image is a point image or a line image.
